(19) United States
(12) Patent Application Publication
(10) Pub. No.: US 2025/0041943 A1
(43) Pub. Date: Feb. 6, 2025

(54) MACHINE FOR ADDITIVE MANUFACTURING BY POWDER BED DEPOSITION

(71) Applicant: ADDUP, Cebazat (FR)

(72) Inventor: LUDOVIC ANGELE, Cebazat (FR)

(21) Appl. No.: 18/722,802

(22) PCT Filed: Dec. 22, 2022
(86) PCT No.: PCT/FR2022/052476

§ 371 Date: Jun. 21, 2024

(30) Foreign Application Priority Data
Dec. 23, 2021 (FR) FR2114411

(51) Int. Cl. B22F 12/33; B22F 10/28; B33Y 10/00; B33Y 30/00

(52) U.S. Cl. CPC B22F 12/33; B22F 10/28; B33Y 10/00; B33Y 30/00

(57) ABSTRACT

A machine for additive manufacturing by powder bed deposition comprises an enclosure (10) comprising a separating wall (23) arranged so as to separate an upper chamber (20) and a lower chamber (30), an actuator (31) disposed in the lower chamber, means for depositing a powdered material, and a consolidating device (80) for selectively consolidating each powder layer. The upper chamber comprises an opening (21) for the passage of a manufacturing sleeve having a manufacturing plate (47), and the machine comprises a transfer system (91) configured to transfer the manufacturing sleeve from a manufacturing position to the opening, the transfer system also being configured to transfer the manufacturing sleeve from the opening to the manufacturing position.

### FIELD OF THE INVENTION

The present invention relates to additive manufacturing by powder bed deposition, and notably to metal additive manufacturing.

It more particularly proposes a machine for manufacturing by powder bed having an improved unloading system.

### PRIOR ART

FIG. 1 shows a known machine for additive manufacturing by powder bed deposition. This additive manufacturing machine comprises a manufacturing enclosure 10 and a device 80 for selectively consolidating the powder layers. This consolidating device is, for example, a laser or an electron source in the case of a metal powder to be fused, or a binder jet in the case of a powder.

The layer of additive manufacturing powder is deposited inside the manufacturing enclosure 10, on a horizontal powder-receiving surface 61 situated in a work area defined by a build sleeve 400 and a movable manufacturing plate 47. The manufacturing sleeve 400 is held by a work surface 62 and extends vertically beneath said work surface 62. The sleeve 400 opens into the work surface 62. The manufacturing plate 47 slides along a vertical axis (Z) inside the manufacturing sleeve 400 under the effect of an actuator 31. The machine also comprises a powder distributing device (not shown) for depositing a powder 70 layer by layer on the work area inside the sleeve 400. Then, the powder 70 is selectively consolidated on the powder receiving surface 61 by the consolidating device 80.

When manufacturing starts, the actuator 31 is deployed completely and the upper surface of the manufacturing plate 47 is situated in the work surface 62. During the manufacturing, the layers are deposited successively on the plate 47, and said plate 47 is lowered between the steps of depositing the successive layers, such that the layer deposited last is disposed on the powder receiving surface 61 at all times during the manufacturing. When manufacturing ends, the manufacturing plate 47 is situated at the bottom of the manufacturing sleeve 400 and the sleeve 400 contains one or more objects 75 that were manufactured during the process and are surrounded by a large amount of non-consolidated powder 70 from the areas of powder layers 70 not corresponding to a section of the one or more objects 75 to be manufactured. In addition, the objects 75 can also contain a large amount of non-consolidated powder 70 from the recessed areas of the objects 75 to be manufactured.

After the manufacturing step, the sleeve is unloaded, which is to say the non-consolidated powder is extracted by suction and the one or more manufactured parts 75 is removed. The additive manufacturing machine typically comprises a door for opening the manufacturing enclosure 10 and allowing an operator to access both the sleeve containing the manufactured objects and the non-consolidated powder.

In particular, for processes in which the consolidation is carried out by melting using an energy source such as a laser beam or an electron beam, the temperature inside the sleeve can reach values between 200° C. and 500° C. However, in accordance with the standards in force and in order to protect the operator and minimize the risk of burns or an explosion, the temperature inside the sleeve must not exceed 60° C. for the opening of the enclosure 10 and the unloading of the sleeve. This requires several hours of cooling the contents of the sleeve at the end of the process and before unloading, during which the manufacturing machine is inactive. The waiting time for the powder and the one or more manufactured parts 75 to cool thus causes a considerable loss of productivity. In addition, opening the machine to remove the sleeve causes disruption of the inert atmosphere present in the machine.

It is possible to envisage removing the sleeve from the additive manufacturing machine before the cooling. Document EP 1 194 281 proposes a system for unloading the sleeve containing the manufactured part and the non-consolidated powder in the lower area of the machine, which is to say underneath the work surface. Such a system is complex and difficult to implement owing to the considerable size of the actuator that displaces the manufacturing plate in the sleeve. Furthermore, such a system runs the risk of introducing the powder into the lower area of the machine, which is generally something to be avoided.

Another possible solution is to unload the manufactured objects and the non-consolidated powder without taking the sleeve out of the additive manufacturing machine. Documents US 2015 0239177 and WO2017/191250 disclose discharging the manufactured objects and the non-consolidated powder into a container. In these devices, the manufacturing sleeve is kept inside the enclosure and cannot be dismounted. This involves transferring the manufactured objects and the non-consolidated powder towards the container, which is a complex operation insofar as it is necessary to ensure powder-tightness between the sleeve and the container.

### SUMMARY OF THE INVENTION

An aim of the invention is to propose a solution which is simple and easy to implement and enables unloading without waiting for the manufactured part and the non-consolidated powder surrounding it to cool.

Yet another aim is to propose a solution which enables such unloading without introducing powder into those portions of the machine that are difficult to clean.

To that end, the invention proposes a machine for additive manufacturing by powder bed deposition, comprising
an enclosure comprising a separating wall arranged horizontally so as to separate an upper chamber extending above the separating wall and a lower chamber extending below the separating wall, and
an actuator disposed along a vertical axis in the lower chamber,
means for depositing a powdered material suitable for depositing at least one powder layer on top of a manufacturing plate, and
a consolidating device for selectively consolidating each powder layer deposited on top of the manufacturing plate,
   said machine being configured to receive a manufacturing sleeve having a manufacturing plate in a manufacturing position in which the manufacturing sleeve extends below the separating wall into the lower chamber, the manufacturing plate being translationally movable along the vertical axis inside the manufacturing sleeve under the effect of the actuator, said sleeve and said manufacturing plate defining a work area,
   said machine being characterized in that the upper chamber comprises an opening for the passage of a manufacturing sleeve having a manufacturing plate, and in that the machine comprises a transfer system configured to transfer the manufacturing sleeve from the manufacturing position to the opening, and the transfer system also being configured to transfer said manufacturing sleeve from the opening to the manufacturing position in the upper chamber.

The sleeve preferably comprises retaining means for retaining the manufacturing plate in the sleeve. Advantageously, the retaining means comprise an inner rim present in the bottom portion of the sleeve.

The machine preferably additionally comprises anchoring and/or referencing means configured to hold and/or adjust the sleeve in the manufacturing position in relation to the separating wall.

Advantageously, the machine additionally comprises locking means capable of holding and releasing the manufacturing plate with respect to the actuator.

In some embodiments, the machine is configured to receive a sleeve closed by a cover impervious to the inert gas, said machine comprising a cover handling device configured to allow access to the work area in the manufacturing position, and to close the sleeve imperviously to the inert gas while it is being transferred from the manufacturing position to the opening.

Advantageously, the additive manufacturing machine additionally comprises at least one seal which is impervious to the powder and arranged between the sleeve and the separating wall and/or between the sleeve and the manufacturing plate.

The invention also relates to an additive manufacturing station comprising a machine as described above and at least one transfer shuttle which can be connected to the opening of the upper chamber of the machine and is capable of transporting a manufacturing sleeve having a manufacturing plate.

The invention also relates to an additive manufacturing process comprising the following steps implemented in an additive manufacturing machine as described above:
making available a manufacturing sleeve having a manufacturing plate via the opening provided in the upper chamber,
transferring said sleeve to a manufacturing position in which said sleeve extends below the separating wall into the lower chamber,
depositing and consolidating at least one powder layer inside the sleeve,
transferring said sleeve from the manufacturing position to the opening,
taking the sleeve out of the upper chamber of the manufacturing machine.

The process preferably additionally comprises a step of transferring said sleeve and the manufacturing plate from the upper chamber of the machine to a transfer shuttle.

Advantageously, the process additionally comprises a step of assembling a manufacturing sleeve and a manufacturing plate in a station external to the additive manufacturing machine.

### BRIEF DESCRIPTION OF THE FIGURES

Further features and advantages of the invention will emerge from the following detailed description, with reference to the appended drawings, in which:

FIG. 1 is a schematic view of a known machine for additive manufacturing by powder bed deposition.

FIG. 2 is a schematic view, in section, of a machine for additive manufacturing by powder bed deposition according to the invention and a transfer shuttle, while a sleeve is being loaded.

FIG. 3 is a schematic view, in section, of a machine for additive manufacturing by powder bed deposition according to the invention and a transfer shuttle during an additive manufacturing process.

FIG. 4 is a schematic view, in section, of a machine for additive manufacturing by powder bed deposition according to the invention and a transfer shuttle, while a sleeve is being unloaded.

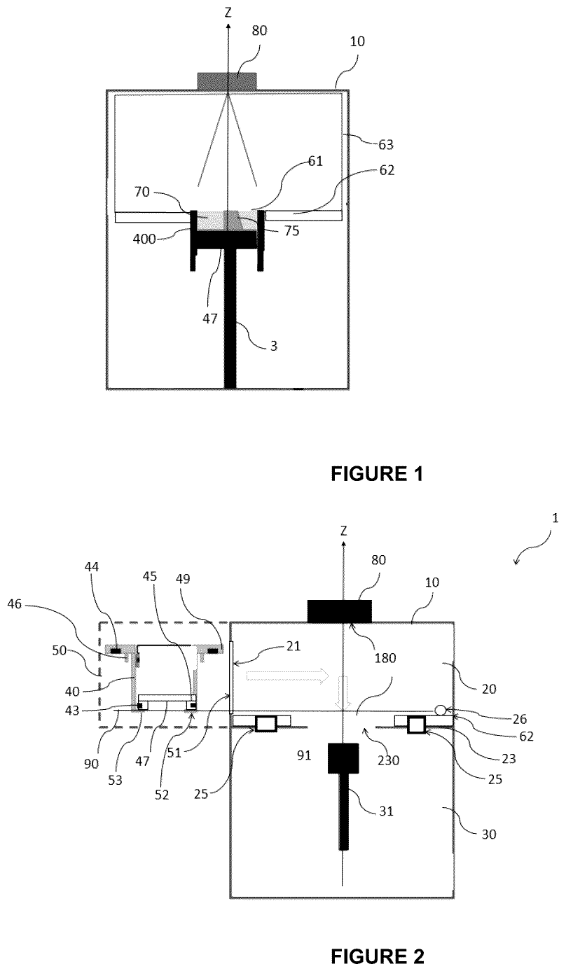

### DETAILED DESCRIPTION OF EMBODIMENTS

### General Provisions

With reference to FIG. 2, the additive manufacturing machine 1 comprises a manufacturing enclosure 10 comprising an upper chamber 20 and a lower chamber 30, and a separating wall 23 which is arranged between said chambers 20, 30 and forms a work surface 62. The enclosure 10 may, for example, be made of metal sheets and comprises one or more doors for accessing its various chambers. Advantageously, the enclosure is under a controlled or inert atmosphere, for example filled with an inert gas such as dinitrogen or argon.

The upper chamber 20 comprises means for depositing a powdered material which deposits the powder layer by layer. For example, these means for depositing powder layers comprise one or more powder distributing devices 25 and a powder spreading device 26, which can take the form of a scraper or a roller. The powder constitutes the starting material for one or more objects to be manufactured. Typically, the powder is a powder of metal, for example made of steel, or a metal alloy, for example on the basis of nickel, cobalt, titanium, copper or aluminium. In some cases, the powder may be made of ceramic, an intermetallic compound, or a polymer or another composite material. The grains have, for example, a diameter between 5 and 100 μm. In some cases, the powder is a powder made of ceramic or of plastic. The manufacturing chamber 20 may also have a receptacle or another device intended to receive excess powder during an additive manufacturing process.

The upper chamber 20 additionally comprises a powder consolidating device 80. Illustratively and non-limitingly, the consolidating device 80 is a laser source or a source generating an electron beam. The consolidating device 80 may be another device designed to locally heat the powder. In some embodiments, the consolidating device 80 is a binder distributing device. The consolidating device 80 may be arranged inside the upper chamber 20. In some cases, the consolidating device 80 is arranged outside the upper chamber 20, and the upper chamber 20 comprises a passage such as a window or an orifice 180 configured for the passage of a consolidating means, for example a laser beam or an electron beam or a binder jet.

The upper chamber 20 additionally comprises an opening 21 which forms a passage for a manufacturing sleeve 40 and to which a transfer shuttle 50 can be connected. The connection between the upper chamber 20 and such a transfer shuttle 50 is preferably impervious to the powders and/or the gases with respect to the outside of the enclosure and the transfer shuttle 50. When no shuttle 50 is connected to the opening 21, said opening 21 can be closed so as to be impervious to the powder and/or a gas, for example by a sliding hatch or cover 48 comprising a seal. The upper chamber 20 additionally comprises a transfer system 91 configured to transfer a manufacturing sleeve 40 between a manufacturing position, described later on, and the opening 21. Non-limitingly, such a transfer system 91 may be a system of lower, lateral and/or upper rails, one or more grooves, a cable transport system, or a combination of several of said transfer systems.

The separating wall 23 comprises an orifice 230 capable of receiving a sleeve 40 in which a manufacturing plate 47 is arranged. The separating wall 23 may be made from metal or ceramic or another material suitable for supporting a manufacturing sleeve 40 and withstanding the temperatures of the enclosure. The wall 23 is preferably impervious to the powder, apart from the orifice 230.

The wall 23 is, for example, impervious to the gases and the manufacturing sleeve 40 may comprise a seal 44 impervious to the powders and/or to a gas when a sleeve 40 is inserted in the orifice 230. Such a seal may, for example, be a static seal of the O ring type.

The manufacturing plate 47 is intended to be displaced axially in the sleeve 40 during the manufacturing, whereas the sleeve 40 remains immobile in the orifice 230 and in relation to the wall 23 during the manufacturing. The sleeve 40 may be made of sheet metal and the manufacturing plate 47 may, for example, be made of metal or of ceramic. To slide in the sleeve 40, the manufacturing plate 47 may be mounted on an annular guiding support 45, which is itself mounted in the sleeve 40.

The sleeve 40 may be essentially parallelepipedal, in the form of a cube or a cylinder, or have another geometry suitable for the objects to be manufactured. Together with the plate 47, the sleeve 40 defines a manufacturing volume with a horizontal and vertical extent. When the sleeve 40 is inserted in the orifice 230 of the separating wall 23, the sleeve 40 extends below the separating wall 23 into the lower chamber 30. The sleeve 40 additionally comprises elements capable of connecting the sleeve 40 to the transfer system 91. The sleeve 40 may have a sliding hatch or cover 48 which can be retracted or opened, for example by folding it. In this case, the sliding hatch or cover 48 is preferably impervious to the powders and/or to the gases. Advantageously, the sleeve 40 has an outer rim 49 which is caught on and extends above the orifice 230. The outer rim 49 may comprise one or more seals 44 which come into contact with the separating wall 23, so as to produce a connection impervious to the gases and/or to the powders. Such a seal 44 may, for example, be a static seal of the O ring type.

Advantageously, the sleeve 40 and/or the wall 23 comprise complementary anchoring and/or referencing means. For example, pegs 46 borne by the outer rim 49 of the sleeve 40 interact with complementary reference holes formed in the wall 23. These anchoring and/or referencing means hold the sleeve 40 in a manufacturing position when said sleeve is placed in the orifice 230. Further means can be envisaged as an alternative or in addition to ensure the anchoring and referencing, for example:
for the referencing, a positioning rod or stop, an optical system or an electronic system comprising a position sensor;
for the anchoring, fixing elements capable of locking the sleeve 40 in its manufacturing position, such as locking levers or screws, or an automatic locking system with a cylinder or a zero point.

The manufacturing plate 47 is arranged horizontally inside the sleeve 40 and translationally movably inside the sleeve 40 under the effect of an actuator 31. The plate 47 is intended to receive the various successive powder layers and to support a part 75 while it is being manufactured. The manufacturing plate 47 may have a circular, rectangular, square or other shape, depending on the horizontal geometry of the sleeve 40. One or more seals 43 are preferably arranged between the sleeve 40 and the manufacturing plate 47 so as to produce a transition which is impervious to the gases and/or to the powders. Such a seal 43 may, for example, be a dynamic seal made of Kevlar braid. Such a seal 43 may, for example, be installed between the annular support 45 and the sleeve 40. The sleeve 40 and the manufacturing plate 47 make it possible to keep a manufactured part 75 and the non-solidified powder surrounding it on the plate 47 in a predefined volume.

The lower chamber 30 comprises a linear actuator 31 configured to cause a translational movement of the manufacturing plate 47 in a vertical direction. In the present text, “vertical” means, as commonly accepted, in the direction of gravity. “Horizontal” means perpendicularly to the vertical. The description of the additive manufacturing machine 1 is given assuming that the separating wall 23 extends in a horizontal plane, as shown in FIGS. 2 to 4.

Actuator means an electronically and/or pneumatically controlled mechanism which is capable of producing a relative translational movement between the two entities that it links, in particular a linear actuator capable of creating a linear movement. The actuator 31 is thus typically of the cylinder type, with a fixed, often tubular, main portion in which a movable part is translationally movable on demand. The cylinder may be purely electromechanical, for example having a screw-nut mechanism, pneumatic, hydraulic or use any other type of technology defined on the basis of characteristics regarding force, velocity, travel, shape and weight, and especially positional accuracy, which are specific to the additive manufacturing field. Those skilled in the art will understand that the invention is not limited to cylinders, and that the one or more actuators 31 could make use of other technologies, and be for example ball screws or endless screws. The additive manufacturing machine preferably additionally comprises locking means, for example mechanical snap-fastening means, capable of holding and releasing a manufacturing plate 47 with respect to the head of the actuator 31.

The lower chamber 30 is preferably free of powder. This eliminates any risk of contamination of or damage to the electronic, hydraulic and mechanical mechanism of the actuator 31 owing to the presence of powder.

The additive manufacturing machine 1 has a horizontal powder-receiving surface 61 in which the material is consolidated. When the consolidating means is a laser beam or an electron beam, the horizontal powder-receiving surface 61 is preferably situated in the focal plane of said beam. The manufacturing plane is fixed in the vertical direction in relation to the separating wall 23 and may be above, below or at the same height as said wall 23. In the manufacturing plane, the manufacturing sleeve 40 defines a work area in which the additive manufacturing process is carried out.

The transfer shuttle 50 is a container capable of receiving at least one additive manufacturing sleeve 40 with a plate 47. The shuttle 50 comprises at least one opening 51 through which a sleeve can be loaded and unloaded. The opening 51 may be closed, for example by a sliding hatch or cover. In some cases, the shuttle 50 may comprise two or more different openings, for example a first opening capable of being connected to an additive manufacturing machine, a second opening capable of being connected to a cooling station, and/or a third opening capable of being connected to a depowdering or storage station. The transfer shuttle 50 may have similar or different openings on multiple sides, making it possible for example to successively connect it to multiple machines or stations facing one another.

The transfer shuttle 50 is preferably movable on an automatic or manual transport system such as a rail system or a carriage or another movable support forming part of an additive manufacturing installation. It is thus possible to arrange the transfer shuttle 50 such that the opening 51 of the shuttle 50 faces the opening 21 of the upper chamber 20 of the additive manufacturing machine 1. The transfer shuttle 50 may be transported to a cooling and/or storage and/or depowdering station by the same transport system.

Advantageously, the shuttle 50 and/or the upper chamber 20 has a device for connecting the opening 51 of the transfer shuttle 50 and the opening 21 of the upper chamber. Such a connecting device may, for example, comprise a seal and flanges, eyes, elements for screwing, or a bayonet closure. The connection is preferably also impervious to the powders and/or to the gases, for example one utilizing a static seal such as an O ring. The connection can be performed manually or automatedly.

The transfer shuttle 50 may additionally comprise a transfer system 90 configured to transfer a manufacturing sleeve 40 between a fixed position inside the transfer shuttle 50 and the passage formed by the opening 51 of said shuttle. Non-limitingly, such a transfer system 90 may comprise a guide device such as a system of rails on which rollers having the manufacturing sleeve 40 slide. These rollers may be driven by one or more motors.

These rails may be lower, lateral and/or upper rails. As an alternative or in addition, the transfer system 90 may have a cable drive. Advantageously, this sleeve transfer system 90 can be connected to the sleeve transfer system 91 in the upper chamber 20 of the additive manufacturing machine 1 as described above.

The transfer shuttle may additionally have means for holding a sleeve in a fixed position inside the shuttle, for example a support from below, a clamp or snap-fastening means. With preference, when the transfer shuttle 50 comprises a manufacturing sleeve 40 and is transported to the manufacturing machine 1 or from the manufacturing machine 1 to another location, the sleeve 40 is held in a fixed position inside the transfer shuttle 50.

In some embodiments, the shuttle 50 has a connection to an inert gas source and possibly to a pump, so as to fill the shuttle 50 with an inert gas. In this case, the transfer shuttle 50 may be closed imperviously to the inert gas. Typically, the upper chamber 20 of the additive manufacturing machine 1 contains the same insert gas. The transfer shuttle 50 can preferably be connected to the opening 21 of the upper chamber 20 before the device for closing the opening 51 of the transfer shuttle is removed, so as to keep the filling of inert gas in the transfer shuttle 50 and in the upper chamber 20.

In some embodiments, the transfer shuttle 50 can be replaced by a tunnel permanently connected to the opening 21 of the upper enclosure. In other embodiments, the transfer can be made manually, without using a shuttle or a tunnel.

Advantageously, the sleeve 40 comprises retaining means 52 for retaining the manufacturing plate 47 in the sleeve 40. For example, these retaining means 52 comprise an inner rim 53 present in the bottom portion of the sleeve 40.

As illustrated in FIGS. 2 and 4, these retaining means 52 make it possible to keep the manufacturing plate 47 in its bottom position in relation to the sleeve 40 when it is being transferred from the opening 21 to the manufacturing position, and vice versa.

### Operation of the System

With reference to FIG. 2, when an additive manufacturing process is started, the first thing to do is typically to load the sleeve 40 comprising an empty manufacturing plate 47 into the transfer shuttle 50. Typically, the sleeve 40 is loaded through the opening 51 of the shuttle 50 in a sleeve loading station. If the transfer shuttle 50 comprises a sleeve transfer system 90 comprising one or more motors and/or a guide device such as rails or grooves, the sleeve is slid in said transfer system 90. If appropriate, the sleeve 40 is fixed in the system for holding it in a fixed position. Optionally, while the shuttle 50 is being loaded, the sleeve 40 is under inert gas, and closed by a sliding hatch or cover 48 impervious to said gas. It is alternatively possible to fill the shuttle 50 with an inert gas after the sleeve 40 has been loaded in the shuttle 50. In other embodiments, use is not made of an inert gas.

The transfer shuttle 50 is then transferred to the additive manufacturing machine 1 and connects the opening 51 of the shuttle 50 to the opening 21 of the upper chamber 20. This connection is preferably carried out imperviously. If appropriate, the sleeve transfer system 90 of the transfer shuttle 50 is connected to the sleeve transfer system 91 of the upper chamber 20.

In some embodiments, the upper chamber 20 is filled with inert gas. When the transfer shuttle 50 is filled with inert gas, the shuttle 50 is fluidically connected to the upper chamber 20. When the shuttle 50 does not comprise inert gas and the sleeve 40 is filled with inert gas and closed by a sliding hatch or cover 48, the shuttle 50 is connected so as to form a passage for the sleeve 40 while avoiding an exchange of fluid between the shuttle 50 and the upper chamber 20, for example via a lock chamber under inert gas or under a vacuum. Inerting the upper chamber 20 makes it possible to avoid contamination and the formation of oxides during the manufacturing process in order to optimize the mechanical properties of the one or more parts 75 to be manufactured. The inerting additionally makes it possible to avoid the risk of ignition in the presence of the powder and oxygen.

If appropriate, the system for holding the sleeve in a fixed position is deactivated. The next step consists in transferring the sleeve 40 from the transfer shuttle 50 to the upper chamber 20. For this, use is made of the transfer system 90 in the transfer shuttle 50 and the transfer system 91 in the upper chamber 20. With preference, the first thing to do is a transfer in a horizontal direction so as to place the sleeve 40 above the orifice 230 in the separating wall 23. The sleeve 40 is then transferred vertically so as to arrange the sleeve 40 in said orifice 230 in a manufacturing position. Adjustment into the manufacturing position is carried out using the referencing means 46. The sleeve 40 may be fixed in the manufacturing position. Then, and in order to initiate manufacturing, the manufacturing plate 47 is positioned in its uppermost position inside the sleeve 40, the upper surface of the plate 47 being for example aligned with the upper edge of the sleeve 40 and with the work surface 62 and the powder receiving surface 61. At the end of manufacturing, the manufacturing plate 47 may be in its lowest position inside the sleeve 40, in abutment against the inner rim of the sleeve.

In other embodiments, the sleeve 40 is loaded into the upper chamber from a tunnel permanently connected to the opening 21 of the upper chamber. As an alternative, the sleeve 40 is loaded manually directly into the opening 21 of the upper chamber, for example using a handling assistance tool. The sleeve 40 is then transferred to the orifice 230 and to its manufacturing position and things continue as described for the case of the use of a transfer shuttle 50. When the sleeve 40 comprises a sliding hatch or cover 48, the sliding hatch or cover 48 is withdrawn or opened before or during or after the transfer of the sleeve 40 into the upper chamber 20 by a cover handling device, for example a clamp system or one or more magnets.

The shuttle 50 may be withdrawn from the upper chamber 20 or remain connected during the additive manufacturing process. When the shuttle 50 is withdrawn, the upper chamber 20 is closed, preferably imperviously to the powders and/or to the gas.

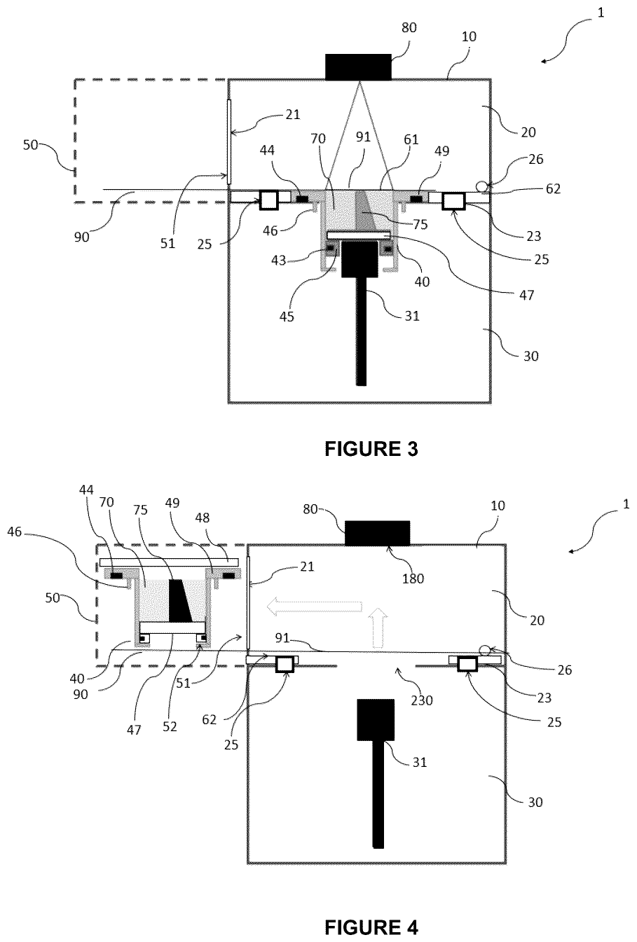

With reference to FIG. 3, it is then possible to start a process for additively manufacturing one or more parts 75 in the sleeve 40. Powder layers are successively deposited on the powder receiving surface 61. The powder is consolidated, for example layer by layer or in several layers, for example by total or partial selective melting carried out using the consolidating device 80. As the parts 75 are manufactured, it is necessary for the plate 47 to be lowered in relation to the powder receiving surface 61. This is because additive manufacturing consists in successively adding material layers of a part 75. The manufacturing plane, in which the powder is melted, remains unchanged throughout the procedure. As a result, the plate 47 is displaced vertically towards the lower chamber 30 by the actuator 31 such that only the layer being manufactured is situated in the plane of the powder receiving surface 61.

When the additive manufacturing process is finished, the plate 47 is at the bottom of the sleeve 40, and the sleeve 40 contains the one or more manufactured parts 75 submerged in a bed of non-consolidated powder 70. At this stage, the temperature inside the sleeve 40 is significantly higher than the ambient temperature outside the machine 1. For example, during an additive manufacturing process in which the consolidating device 80 is a laser source or an electron source, the temperature inside the sleeve 40 may be between 200° C. and 500° C.

It is now possible, if appropriate, to unlock the sleeve 40 from the manufacturing position and/or close up the sleeve 40 using the sliding hatch or cover 48. If the transfer shuttle 50 was removed during the manufacturing process, a transfer shuttle 50 is connected to the opening 21 of the upper chamber 20. Then, with reference to FIG. 4, the sleeve 40 is transferred from the manufacturing position to the opening 21 and the transfer shuttle 50. With preference, the first thing to do is make a transfer in the vertical direction so as to position the sleeve 40 at the same height as the opening 21, and then a transfer is made in the horizontal direction to the transfer shuttle 50 and the opening 21. If appropriate, it is possible to close the sleeve 40 using a sliding hatch or cover 48 during the transfer into the shuttle 50. If appropriate, the sleeve 40 is fixed in a fixed position in the transfer shuttle 50.

Then, the shuttle 50 is disconnected from the opening 21 of the upper chamber 20. It is then possible to close the opening 21 of the upper chamber 20 or connect another shuttle comprising an empty sleeve 40 to the opening 21 of the upper chamber 20. It is thus possible to directly start a new additive manufacturing process using the empty sleeve 40.

The shuttle 50 comprising the sleeve 40 containing the manufactured parts 75 in a powder bed 70 can be transferred to a cooling and/or storage and/or depowdering station. Such a station comprises at least one opening and a transfer system equivalent to the transfer system 91 in the upper chamber 20. The sleeve 40 can be kept inside the transfer shuttle 50 or be transferred on its own to the cooling and/or depowdering station.

The sleeve 40 is kept in the cooling and/or depowdering station until it reaches the unloading temperature, which is for example less than 60° C. It is now possible to unload the sleeve 40 by removing the powder by suction and taking the manufactured parts 75 out in complete safety.

### Additive Manufacturing Assembly

An additive manufacturing station may comprise one or more additive manufacturing machines and a plurality of sleeves 40 and transfer shuttles 50, and also a cooling and/or storage and/or depowdering station. It is therefore possible to equip each machine with an empty sleeve as soon as a full sleeve is transferred from this machine to the transfer shuttle 50. It is thus possible to perform virtually continuous manufacturing, without a waiting time for the sleeve to cool before unloading.

The sleeves 40 are cooled, for example in the transport shuttle or in a cooling and/or storage and/or depowdering station, with a sufficiently long waiting time. It is not necessary to optimize the waiting time in order to free up the manufacturing machine. As a result, it is possible to provide a safety margin for the cooling temperature, thus avoiding any risk of burns, fire or explosion.

The additive manufacturing station may additionally comprise a station for placing under an inert atmosphere, the station being external to the manufacturing machines. As a result, the transfer shuttles 50 and/or the sleeves 40 are placed under an inert atmosphere in a station shared by all the additive manufacturing machines.

On account of the sleeve 40 being transferred solely via the upper chamber 20 and the transfer shuttle 50, it is possible to keep the lower chamber 30 free of powder, thus avoiding damage to the mechanism of the actuator 31 in each machine. In addition, the unloading of the sleeve via the upper chamber 20 makes it possible to keep the arrangement of the lower chamber 30 of the additive manufacturing machine relatively simple.

1.-11. (canceled)

12. A machine for additive manufacturing by powder bed deposition comprising:
an enclosure comprising a separating wall arranged horizontally so as to separate an upper chamber extending above the separating wall and a lower chamber extending below the separating wall;
an actuator disposed along a vertical axis in the lower chamber;
means for depositing a powdered material suitable for depositing at least one powder layer on top of a manufacturing plate; and
a consolidating device for selectively consolidating each powder layer deposited on top of the manufacturing plate,
wherein the machine is configured to receive a manufacturing sleeve having a manufacturing plate in a manufacturing position in which the manufacturing sleeve extends below the separating wall into the lower chamber, the manufacturing plate being translationally movable along the vertical axis inside the manufacturing sleeve under an effect of the actuator, and the manufacturing sleeve and the manufacturing plate defining a work area,
wherein the upper chamber comprises an opening for passage of the manufacturing sleeve having the manufacturing plate, and
wherein the machine comprises a transfer system configured to transfer the manufacturing sleeve from the manufacturing position to the opening, the transfer system being configured to transfer the manufacturing sleeve from the opening to the manufacturing position in the upper chamber.

13. The machine according to claim 12, wherein the manufacturing sleeve comprises retaining means for retaining the manufacturing plate in the manufacturing sleeve.

14. The machine according to claim 13, wherein the retaining means comprise an inner rim present in a bottom portion of the manufacturing sleeve.

15. The machine according to claim 12, further comprising anchoring and/or referencing means configured to hold and/or adjust the manufacturing sleeve in the manufacturing position in relation to the separating wall.

16. The machine according to claim 12, further comprising locking means capable of holding and releasing the manufacturing plate with respect to the actuator.

17. The machine according to claim 12, wherein the machine is configured to receive a manufacturing sleeve closed by a sliding hatch or cover impervious to inert gas, the machine comprising a cover handling device configured to allow access to the work area in the manufacturing position and to close the manufacturing sleeve imperviously to the inert gas while the manufacturing sleeve is being transferred from the manufacturing position to the opening.

18. The machine according to claim 12, further comprising at least one seal which is impervious to the powdered material and arranged between the manufacturing sleeve and the separating wall and/or between the manufacturing sleeve and the manufacturing plate.

19. An additive manufacturing station comprising the machine according to claim 12 and at least one transfer shuttle configured to be connected to the opening of the upper chamber of the machine and to transport the manufacturing sleeve.

20. An additive manufacturing process comprising the following steps implemented in the additive manufacturing machine according to claim 12:
providing the manufacturing sleeve having the manufacturing plate via the opening provided in the upper chamber;
transferring the manufacturing sleeve to the manufacturing position in which the manufacturing sleeve extends below the separating wall into the lower chamber;
depositing and consolidating at least one powder layer inside the manufacturing sleeve;
transferring the manufacturing sleeve from the manufacturing position to the opening; and
taking the manufacturing sleeve out of the upper chamber of the manufacturing machine.

21. The process according to claim 20, further comprising a step of transferring the manufacturing sleeve and the manufacturing plate from the upper chamber of the machine to a transfer shuttle.

22. The process according to claim 20, further comprising a step of assembling the manufacturing sleeve and the manufacturing plate in a station external to the machine.
